(19) United States
(12) Patent Application Publication
(10) Pub. No.: US 2020/0406413 A1
(43) Pub. Date: Dec. 31, 2020

(54) Quick-Change Tool Holder Centerline-Position Adjustment Device Having A Plurality Of Variable And Selectable Settings

(71) Applicant: Jonathan Joseph Mattox, Charlotte, NC (US)

(72) Inventor: Jonathan Joseph Mattox, Charlotte, NC (US)

(21) Appl. No.: 16/452,607

(22) Filed: Jun. 26, 2019

(51) Int. Cl. B23Q 3/18; B23Q 3/10

(52) U.S. Cl. CPC B23Q 3/186; B23Q 3/108; B23Q 3/107

(57) ABSTRACT

A Quick-Change Tool Holder (QCTH) centerline-position adjustment device is provided herein which is characterized by a device which provides for a plurality of distinct and variable position settings to be selected individually. The individual settings are selected by rotation of an indexable ring which contains a plurality of set screws which can be individually adjusted. The rotation of the indexable ring is about the central shaft which is mounted to the Quick Change Tool Holder.

### BACKGROUND OF THE INVENTION

### I. Field of the Invention

The present invention pertains generally to tool holders for machine tools such as lathes, boring machines, turning machines and the like. Machine tools are devices used to cut, shape, and form rigid materials such as metals, plastics, ceramics, composites, etc. There are thousands of different types of cutting, forming, and shaping tools which interact directly with the material. The present invention is relevant to operations which require the tool to be set and fixed with its cutting, forming, or shaping edges/surfaces aligned with or intentionally offset from a plane which passes through the rotational axis of the workpiece and is also normal to the direction of tool position adjustment. One example of this alignment between the tool and the workpiece is a cutting tool whose position is adjusted until the cutting edge is exactly aligned with the in a lathe for the purpose of cutting the diameter of the workpiece. After being correctly positioned relative to the rotational centerline, the tool can then be traversed in longitudinal and lateral directions to interact with the workpiece.

Specifically the invention relates to a tool holder which is typically used with a Quick-Change Tool Post (QCTP). A QCTP is a device which allows for mounting interchangeable tool holders on a common supporting structure which is attached to the machine tool. The invention is an improved tool holder centerline-position adjustment device which allows the setting and holding of a plurality of positions according to the function, dimensions, and geometry of the different types of tool to be held.

### II. Description of Prior Art

Tool holders have been a critical part of machine tools since shaping and forming operations were undertaken on high strength materials such as metals. The forces created when working such materials require a tool which is rigidly supported by a high strength structure. The combination of strength and rigidity allows the tool to be precisely positioned and to withstand high cutting forces without significant deflection or deformation.

An early type of tool holder is shown in U.S. Pat. No. 750,108A. This type of tool holder is known as a “standard” tool post. The tool is supported on a base and held from above by a clamping screw. Adjustment of the vertical position of cutting edge of the tool is made by a combination of the angle of the base and shims placed directly under the tool, each of these aspects having to be adjusted when a different type of tool is to be used. Disadvantages of this type of tool holder include inaccuracy of adjustments, inability to revert to previous settings, and ability to hold only one tool at a time.

A further development of the tool holder is shown in U.S. Pat. No. 2,908,195. This type is known as a “turret” tool post. This tool post typically has four tool stations and an indexing device which rotates the body around a center support to present each tool to the workpiece. Centerline-position adjustments of each tool are made by placing shims directly under the tool. This type of tool post is often found on turret or capstan lathes built for repetitive work. Disadvantages of this type of tool post include limited versatility and time consuming centerline-position adjustments.

Finally, the piston or wedge type QCTP is shown in U.S. Pat. No. 6,230,595. This type of tool holder consists of a post, usually with dovetail attachments on at least two sides. The individual Quick-Change Tool Holders (QCTH) engage with the dovetails and are locked in place by a piston or wedge type mechanism actuated by a lever. The centerline-position of the QCTHs is typically set by adjusting a knurled nut on a stud protruding from the top of the QCTH. The bottom of the knurled nut contacts the top of the QCTP and sets the position of the tool relative to the rotational axis of the workpiece. Each QCTH has only one stud and knurled nut for adjustment and therefore can only be set for one tool at a time.

### SUMMARY OF THE INVENTION

The invention is a Quick-Change Tool Holder centerline-position adjustment device which provides for a plurality of distinct centerline-position settings that can be varied and selected individually.

The invention is characterized by a central shaft with a threaded bottom portion which is mounted in the threaded hole on the top of a typical QCTH. Around this central shaft rotates an indexing ring, which is fixed in its axial location on the central shaft by retaining rings. On the indexing ring are a plurality of threaded holes parallel to the bore in a circular pattern. In these threaded holes are installed externally threaded set screws which are used to adjust each centerline-position setting. On the indexing ring are also a plurality of tangentially oriented threaded holes which intersect with the axial threaded holes. In these threaded holes are installed a clamping plug which contacts the periphery of the centerline-position adjusting set screws. Also installed in the tangential holes are short, externally threaded set screws which act on the back surface of the clamping plugs thereby providing the clamping force to secure the position settings of the centerline-position adjusting set screws.

The invention possesses numerous advantages over known tool holder centerline-position adjustment devices. Firstly, the pre-setting of positions allows changing tools in a tool holder without disturbing other aspects of the tool setup. Secondly, the pre-setting of positions decreases the time required to change tools in a tool holder. Thirdly, for a particular style of tool, only one tool holder is necessary for a plurality of individual tools thereby decreasing the overall cost.

Some practical examples of benefits possessed by the invention are as follows. When in use on a lathe, a conventional QCTH must have its vertical position reset when a tool of different function, dimensions, or geometry is to be used, and the process of resetting the centerline-position may disturb other settings which the operator wishes to leave undisturbed. The invention allows the centerline-position of the tool holder to be set for specific tools prior to commencing work, thereby avoiding disturbance of other settings. Furthermore, selecting the desired pre-set centerline-position can be achieved rapidly when changing tools, allowing the entire tool changing process to be completed in less time.

### BRIEF DESCRIPTION OF THE DRAWINGS

FIG. 1 is an isometric view of the centerline-position adjustment device attached to a QCTH and resting on the top surface of the QCTP. The QCTH is mounted to the QCTP and there is a tool mounted in the QCTH. The QCTH and QCTP are prior art and are therefore shown in phantom lines.

FIG. 2 contains a section view (I-I) through the center of the centerline-position adjustment device and the QCTP and QCTH assembly and a top view of the assembly showing the location of the section cut.

FIG. 3 contains a side view of the centerline-position adjustment device and the QCTP and QCTH assembly showing the relative position of the tool working surface/edge to the rotational axis of the workpiece.

FIG. 4 contains an isometric view of the centerline-position adjustment device, and top, bottom, and side views of the centerline-position adjustment device.

FIG. 5 is an exploded isometric view of the centerline-position adjustment device.

FIG. 6 contains three section views (II-II, III-III, and IV-IV) and top and side views of the centerline-position adjustment device to show the locations of the sections. Section II-II is a section along the axis of the central shaft. Section III-III is a section along the axis of one of the four clamping holes. Section IV-IV is a section across the diameter of the indexing ring through the axis of all clamping plugs and clamping screws.

FIG. 7 contains isometric, top, bottom, and side views of the central shaft.

FIG. 8 contains isometric, top, bottom, and side views of the indexing ring.

FIG. 9 contains isometric, top, and side views of the centerline-position stop.

FIG. 10 contains isometric, top, and end views of the clamping plug and clamping screw, and an isometric view of the retaining ring.

### DETAILED DESCRIPTION OF A PREFERRED EMBODIMENT

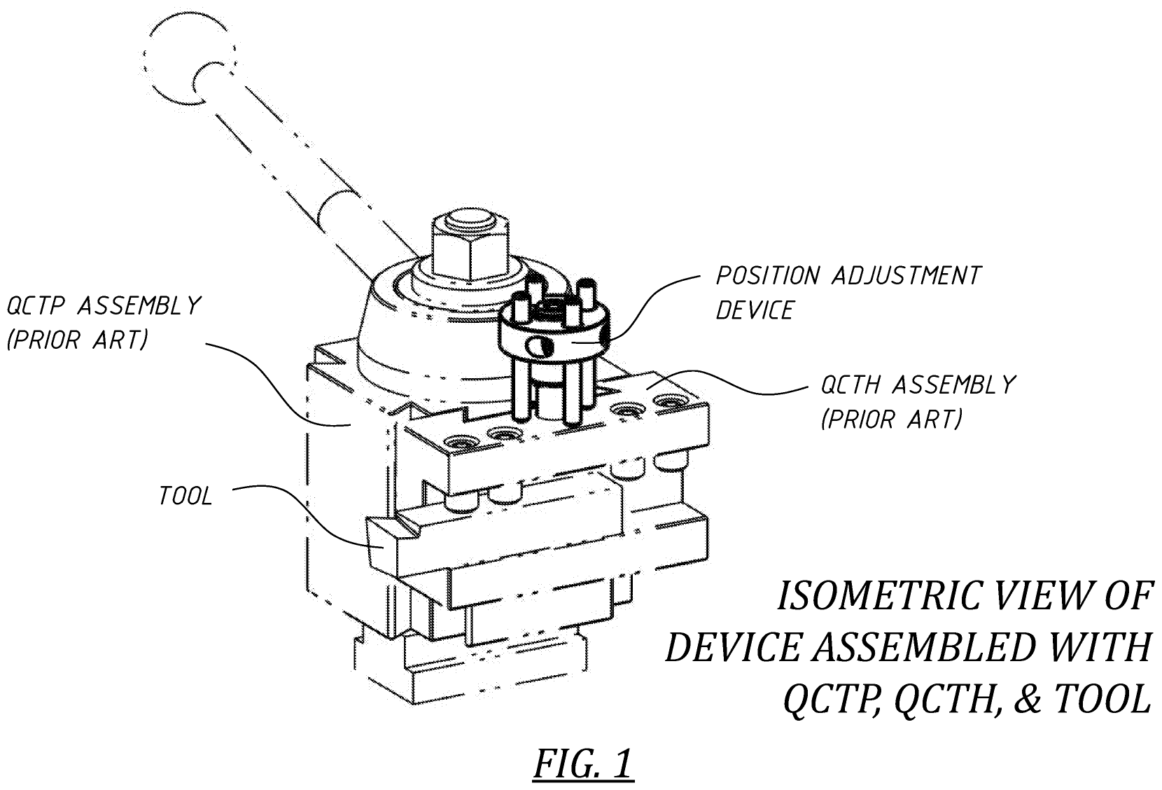

A preferred embodiment of the present invention will now be described with reference to the figures. In the following description reference is made to “top” and “bottom” features which correspond to the typical orientation of a QCTP and QCTH as shown in FIG. 1. However, some machine tools will have the QCTH and QCTP oriented differently with respect to the earth and the use of “top” and “bottom” is used for convenience of description and does not imply a limiting orientation.

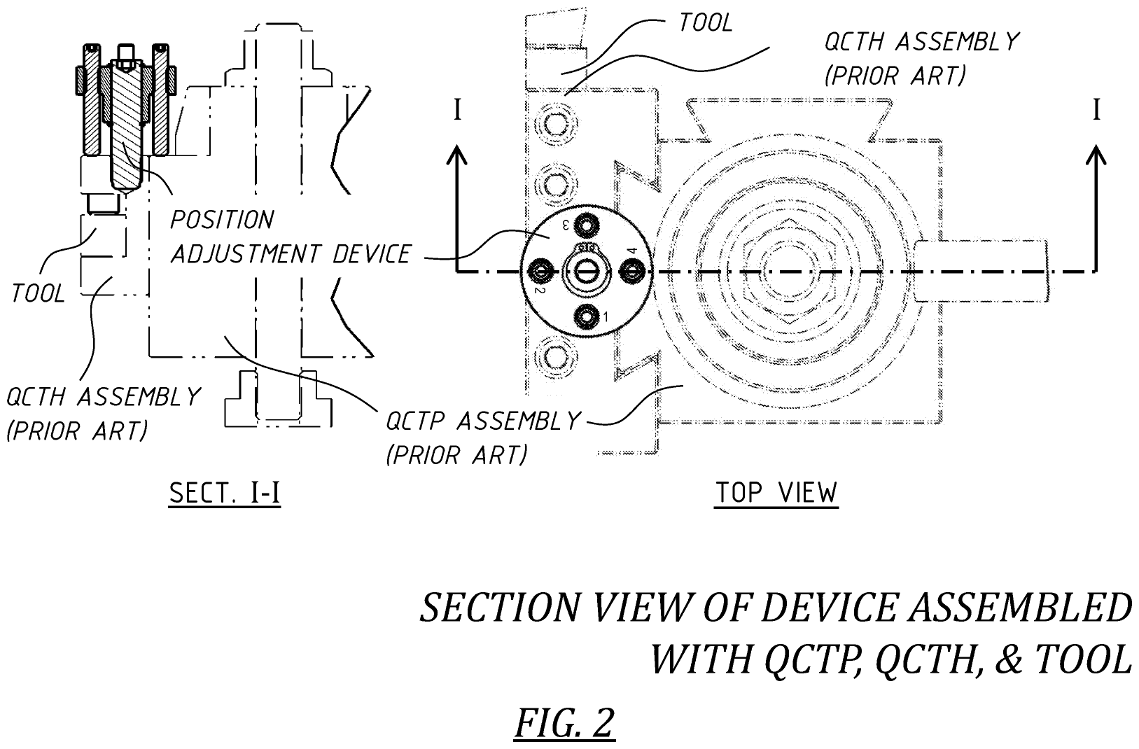

Referring to FIGS. 1 and 2, there is a QCTP and QCTH of typical design which are prior art and therefore are shown in phantom lines. The present invention is shown mounted to the QCTH and engaging with the top of the QCTP.

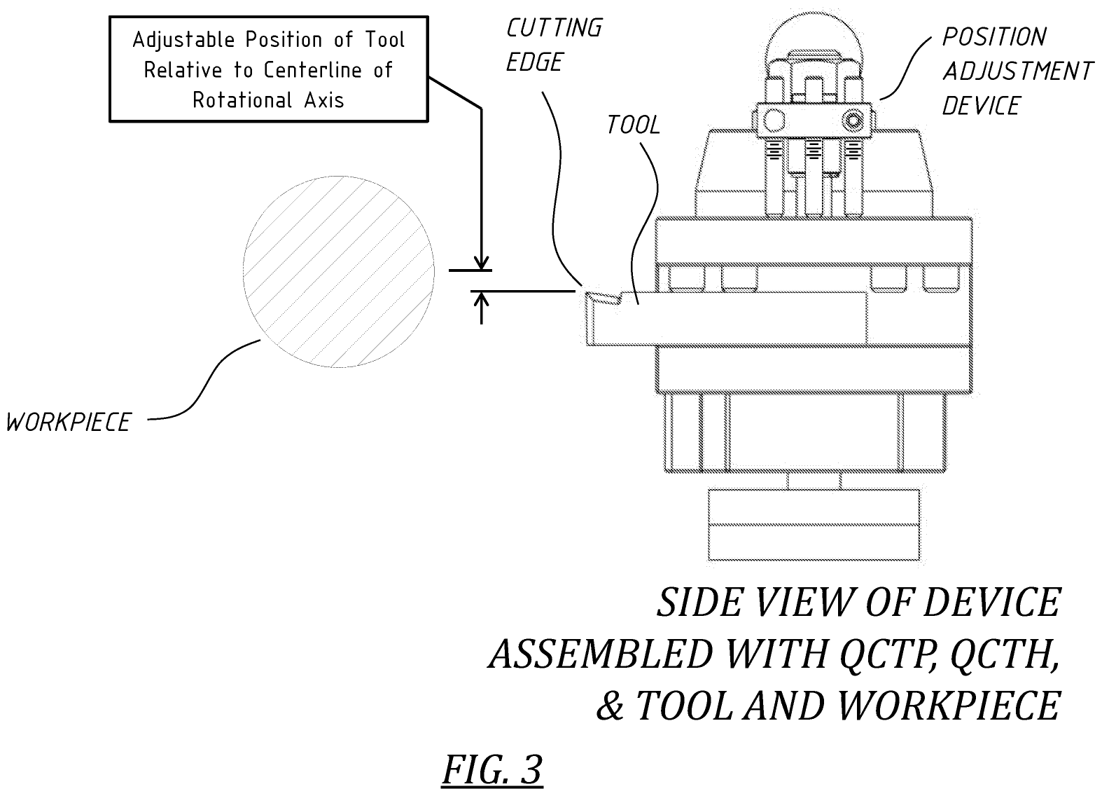

Referring to FIG. 3, there is shown the relationship between the working edge/surface of the tool and the rotational axis of the workpiece.

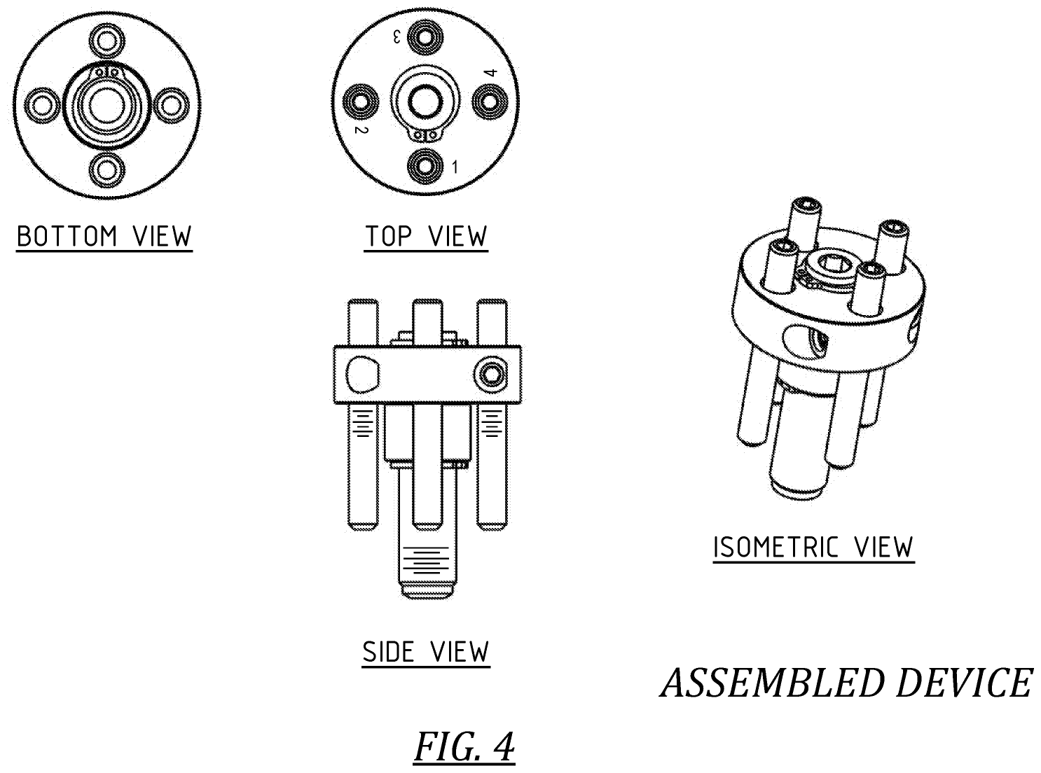

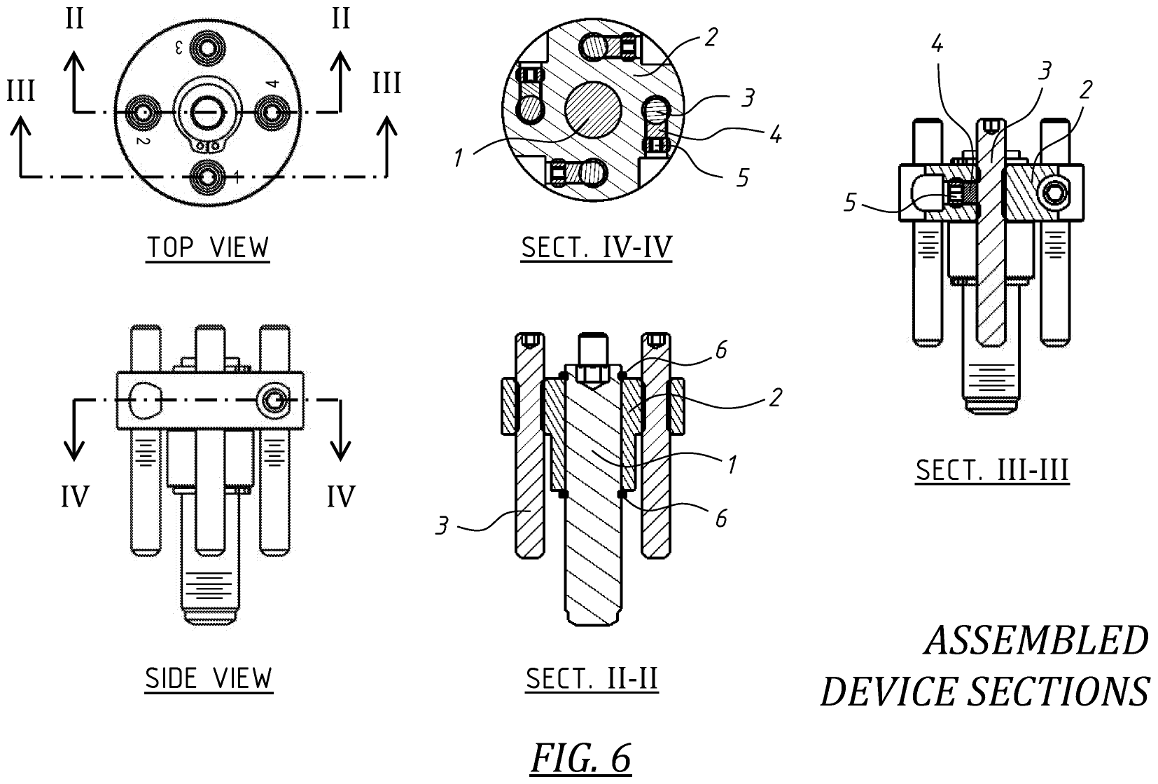

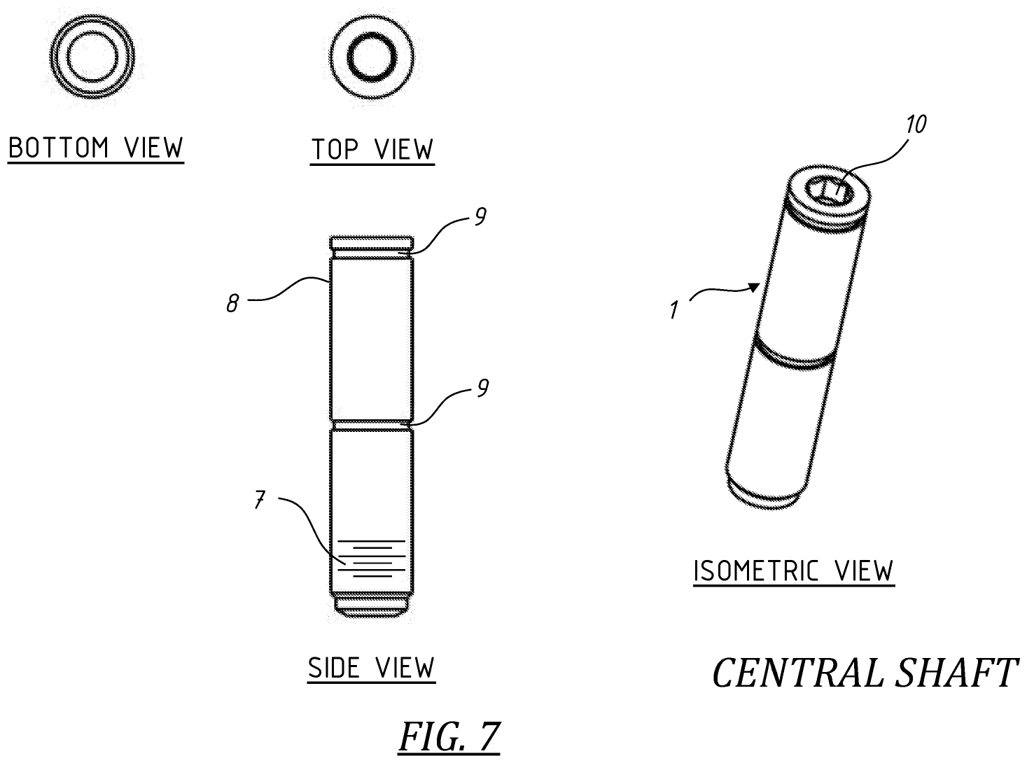

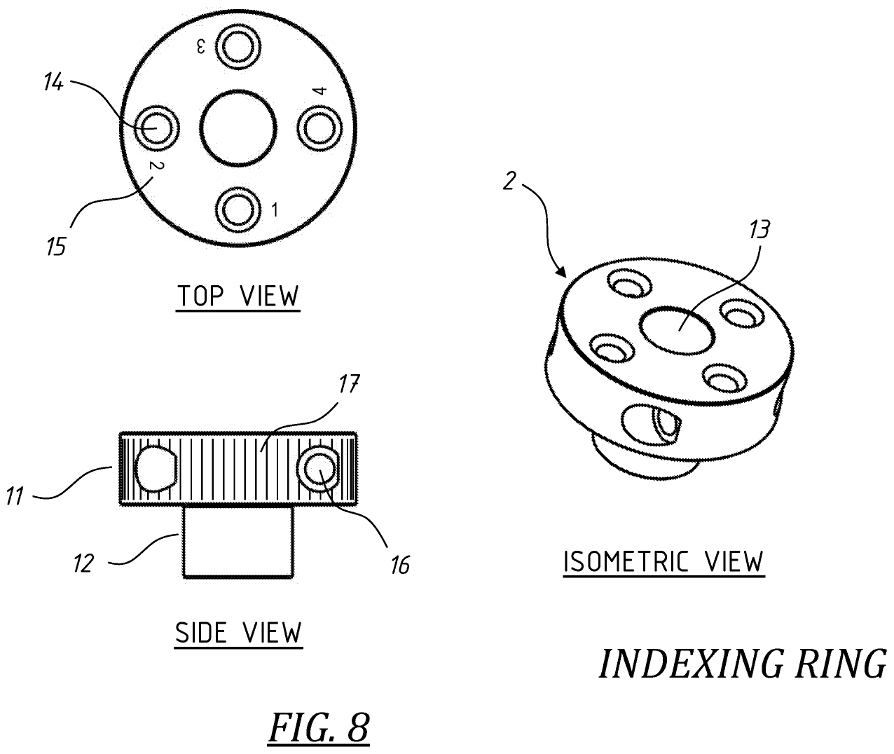

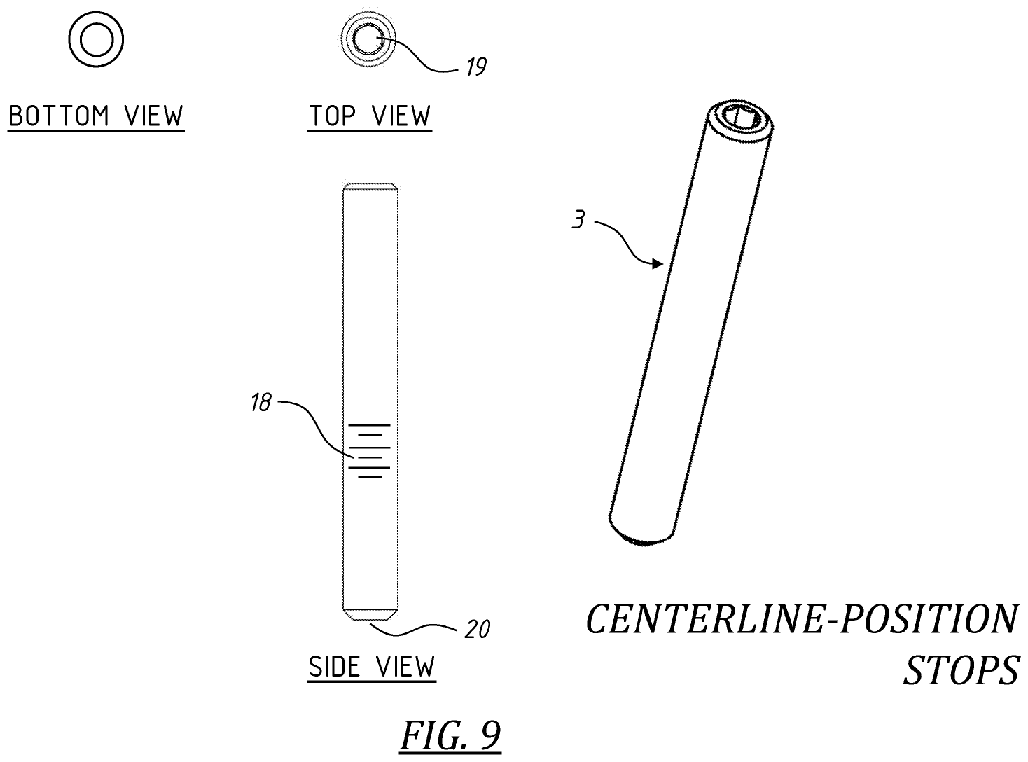

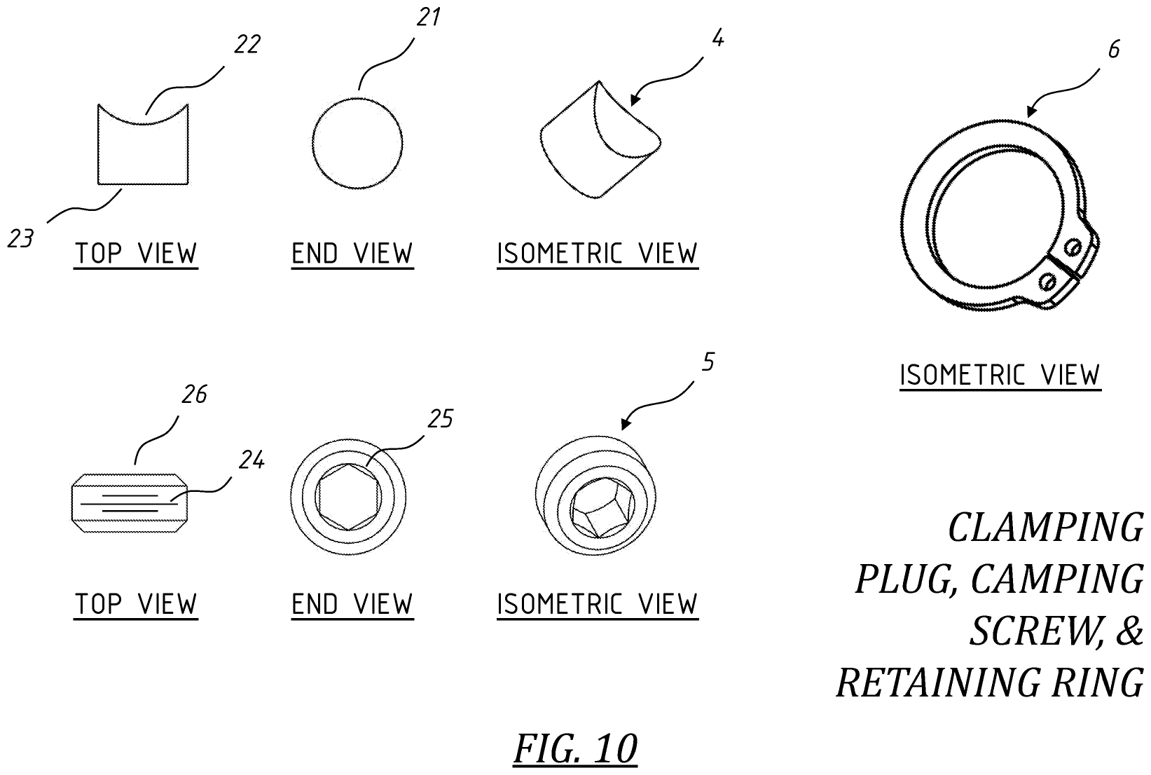

Referring to FIG. 4-10, the following components are shown.

There is shown a central shaft 1 generally having the form of a cylinder. The bottom portion of the shaft is externally helically threaded 7 for mounting to the QCTH. The typical QCTH will already have a helically threaded hole on its top surface to mount the shaft, however in alternate embodiments the shaft may be integral to the QCTH or may be fastened to it by other means such as welding, pinning, press-fitting, etc. An accurate diameter 8 is formed on the upper portion of the shaft to provide a very small and accurate clearance to the indexing ring 2 central bore. Two circumferential grooves 8 are provided on the periphery of the shaft to accommodate retaining rings. In alternate embodiments the retaining ring grooves may instead be replaced by a machined collar, threads for a threaded stop, or other features which allow for axial retention of the indexing ring 2. An internal hexagonal drive 10 is provided on the top of the shaft for tightening of the shaft into the QCTH. In alternate embodiments the internal hexagonal drive 10 on the top of the shaft may instead take other forms and may be located at a position on the shaft other than the top. Features not shown on the shaft, but which may be included in alternate embodiments include a radial hole for a ball and spring, a set of radial holes for an indexing pin or other features to facilitate discreet indexing positions of the indexing ring 2.

There is shown an indexing ring 2 rotatably mounted to the central shaft 1. The indexing ring 2 generally having the form of a stepped cylinder with two different diameters 11 and 12. In alternate embodiments the indexing ring may have different cross sectional shapes such as square, hexagonal, octagonal, etc. The center portion of the indexing ring has a cylindrical bore 13 which provides a small clearance to the shaft on the order of 0.001 inches for accurate locating and smooth operation. In alternate embodiments there may be semi-circular detents in the bore which engage with a ball to facilitate discreet indexing positions. The top surface of the indexing ring is provided with a plurality of helically threaded round holes 14 parallel with the axis of the bore and in a circular pattern around the bore that pass entirely through the thickness of indexing ring. In alternate embodiments the holes may be smooth to accept micrometer heads to serve as centerline-position stops. On the top surface there is shown a unique number 15 in the vicinity of each to identify the index position, this is to facilitate rapid identification of the correct position setting for a particular type of tool. In alternate embodiments the marks may be alpha-numeric, Roman numerals, symbols, etc. and may be located in another visible location on the indexing ring. The outer diameter of the indexing ring is provided with a plurality of tangentially oriented internally helically threaded holes 16 which communicate with the holes 14 on the top surface. In alternate embodiments the holes may be eliminated if another means is provided to lock the centerline-position setting, such as jam nuts, clamp collars, etc. The outer diameter of the indexing ring is knurled 17 to provide better grip for rotating by hand. In alternate embodiments the outer diameter may be smooth, or have an additional gripping component such as a plastic ring, rubber ring, etc.

There are shown centerline-position stops 3. The centerline-position stops are externally helically threaded 18 set-screws. An internal hexagonal drive 19 on the top surface and a flat bottom surface 20. The set-screws engage with the helically threaded holes 14 on the top surface of the indexing ring 2. Rotation of the set screws moves the screws axially for adjustment of centerline-position. The set screws hold the tool positions by resting on the top planar surface of the QCTP.

There are shown clamping plugs 4 generally having the form of a cylinder, which are inserted in and axially moveable in holes 16. The outer diameter 21 of the clamping plugs 4 provides for a sliding clearance on the order of 0.002 inches to the minor diameter of the helically threaded holes 16. The plugs have a concave end 22 which faces inward toward the intersecting holes 14 and a flat end which faces outward. The concave end 22 applies clamping force to the major diameter of the centerline-position stop external helical threads 18.

There are shown clamping screws 5 which apply axial force to the flat ends 23 of the clamping plugs 4. The clamping screws are externally threaded 24 set-screws with an internal hexagonal drive 25 and a flat end face 26. To adjust the centerline-position stops 3 the clamping force is relieved by slightly loosening the clamping screws 5. After adjustment is complete the clamping screws 5 are tightened to hold the set position during machining and tool-changing operations.

There are shown retaining rings 6 which are mounted in circumferential grooves 9 on the central shaft 1. The retaining rings 6 provide axial location for the indexing ring 2. The upper retaining ring 6 resists the axial force along the central shaft 2 from the weight of the QCTH assembly while the QCTP is in the unlocked position. The lower retaining ring 6 provides a small axial clearance on the order of 0.002 inches to the bottom surface of the indexing ring 2.

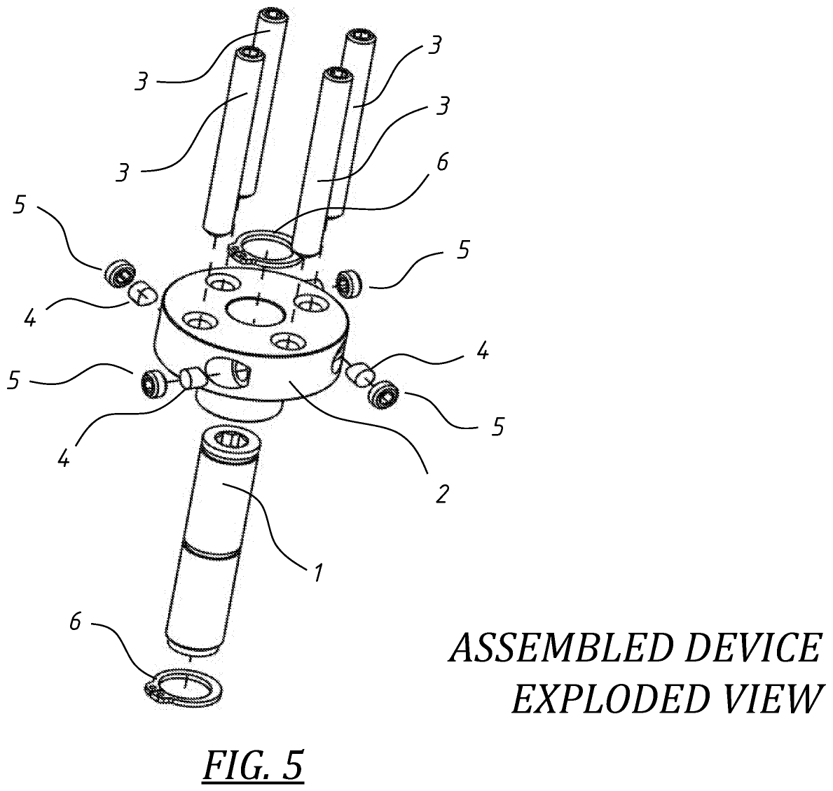

Referring to FIG. 5, in the preferred embodiment all components are made of carbon steel with the exception of the clamping plugs 4, which are made of brass. In alternate embodiments all carbon steel components may be made of other rigid materials including other metals (alloy steel, stainless steel, brass, bronze, iron, aluminum, etc.) various ceramics and carbides, and various composites such as carbon fiber and fiberglass. In alternate embodiments the clamping plugs 4 may be made of other materials which are relatively softer than the centerline-position stops 3 so as not to damage the major diameter of the external threads. These relatively softer materials may include other metals (aluminum, copper, zinc, etc.), plastics, rubbers, etc. In the preferred embodiment all components may have their “as-machined/ground” or “as-formed/deposited” surfaces left as-is. In alternate embodiments there may be various coatings or surface treatments applied to the components such as black-oxide, hard Chromium, carburizing, anodizing, etc.

Referring to FIG. 5, in the preferred embodiment all helically threaded components utilize an internal hexagonal drive for tightening. In alternate embodiments the internal hexagonal drive may instead be some other form of fastener drive such as hexagonal protrusion, external square protrusion, Phillips screw drive, slotted screw drive, etc.

The invention has been explained with respect to a preferred embodiment, but will be understood by those of skill in the art that numerous alterations and variations in the illustrated apparatus may be made without departing from the scope of the invention.

I claim:

1. A Quick-change Tool Post centerline-position adjustment device, comprising:
a. a central shaft having a generally cylindrical shape, with an internal hexagonal drive on its top surface;
b. an indexing ring with a central bore mounted on and rotatable with respect to said central shaft;
c. a plurality of helically threaded screws which are adjustable in axial position by rotation about their individual axis.

2. The central shaft of claim 1 wherein there is a helically threaded lower portion mounted in a Quick-Change Tool Holder assembly.

3. The central shaft of claim 1 wherein the shaft is an integral part of the Quick-change Tool Holder assembly.

4. The central shaft of claim 1 wherein there are two circumferential grooves on the periphery of said shaft spaced axially along its length the approximately the same distance as the thickness of said indexing ring.

5. The central shaft of claim 1, further comprising:
a. a larger diameter near its top surface and a smaller diameter for the remainder of its length;
b. a circumferential groove on the periphery of said shaft directly below the bottom surface of said indexing ring.

6. The indexing ring of claim 1 wherein there are a plurality of helically threaded holes parallel to the axis of the central bore and arranged in a circular pattern around said bore, and with said holes passing through the entire thickness of said indexing ring.

7. The indexing ring of claim 6 wherein there are helically threaded set screws rotatably mounted in each hole with internal hexagonal drives on their top surfaces and where said set screws are adjustable in their position by rotating in said hole.

8. The indexing ring of claim 7 further comprising:
a. a plurality of helically threaded tangentially oriented holes which intersect with said helically threaded holes which are parallel with the central bore;
b. a plurality of set screws rotatably mounted in said tangentially oriented holes;
c. a plurality of cylindrical plugs mounted in said tangential holes, with one end concave and the other end flat, with the concave end of the plugs being in contact with the external threads of said set screws in intersecting holes, the contact force of said plugs being adjustable;
d. a plurality of helically threaded set screws rotatably mounted in said tangential holes and contacting the flat end of said plugs.

9. The indexing ring of claim 7 wherein there are a plurality of jam nuts, one mounted on each said set screw, with said nuts contacting the top surface of said indexing ring.

10. The central shaft of claim 4 wherein there are axial retaining rings mounted in said circumferential grooves.

11. The central shaft of claim 5 wherein there is an axial retaining ring mounted in said circumferential groove.

12. The indexing ring of claim 1 where there are a plurality of smooth holes parallel to the axis of the central bore and arranged in a circular pattern around said bore, and with said holes passing through the entire thickness of said indexing ring.

13. The indexing ring of claim 12 wherein there are a plurality of micrometer heads mounted in said smooth holes.

14. The central shaft of claim 1 further comprising:
a. a smooth radial hole extending partially through said shaft;
b. a compression spring mounted at the bottom of said hole;
c. a ball mounted against said spring in said hole and slightly protruding past the outer diameter of said shaft.

15. The indexing ring of claim 1 wherein there is a plurality of detents in said central bore, with the number of detents equal to the number of holes in said indexing ring, with said detents having consistent angular spacing around said central bore, and with the axial location of said indentions corresponding with axial location of said ball mounted in said shaft.

16. An indexing ring according to claim 7 or 12 further comprising a identifying mark made in the vicinity of each said hole.
